(19) United States
(12) Patent Application Publication
(10) Pub. No.: US 2014/0308879 A1
(43) Pub. Date: Oct. 16, 2014

(54) ADDITIVE FOR POLISHING AGENT, AND POLISHING METHOD

(71) Applicant: ASAHI GLASS COMPANY, LIMITED, Chiyoda-ku (JP)

(72) Inventors: Yuiko YOSHIDA, Tokyo (JP); lori YOSHIDA, Tokyo (JP); Satoshi TAKEMIYA, Tokyo (JP)

(73) Assignee: Asahi Glass Company, Limited, Chiyoda-ku (JP)

(21) Appl. No.: 14/314,565

(22) Filed: Jun. 25, 2014

Related U.S. Application Data
(63) Continuation of application No. PCT/JP2012/082109, filed on Dec. 11, 2012.

(30) Foreign Application Priority Data
Dec. 27, 2011 (JP) 2011-285032

(51) Int. Cl. C09G 1/02; B24B 37/04

(52) U.S. Cl. CPC C09G 1/02; B24B 37/044
USPC 451/41; 51/309

(57) ABSTRACT

The present invention relates to an additive for a polishing agent, which is capable of suppressing a decrease in polishing characteristics of a polishing agent to be repeatedly used, particularly a removal rate, by adding the additive to the polishing agent as needed during repeated uses. The invention also relates to a polishing method using a polishing agent to be repeatedly used, which is capable of suppressing a decrease in polishing characteristics of the polishing agent, particularly a removal rate.

### TECHNICAL FIELD

The present invention relates to an additive for a polishing agent, and a polishing method. More particularly, the invention relates to an additive for a polishing agent to be added to a polishing agent which is repeatedly used for polishing a surface to be polished of a single-crystal substrate, and a polishing method using the same.

### BACKGROUND ART

Techniques for producing and processing wafers of compound single-crystals such as sapphire (α-Al₂O₃), silicon carbide (SiC) and gallium nitride (GaN), as substrates for LEDs or power devices which are expected to greatly glow in the future, are attracting attention. On each of these substrates, a crystalline thin film of GaN or the like is formed to integrate a device, so that a crystallographically less defective, high-quality surface is regarded to be important. In order to obtain such a surface, a chemical mechanical polishing (hereinafter also referred to as CMP) technique is drawing attention.

In CMP of such single-crystal substrates, the polishing agent to be used is generally cycled and repeatedly used. However, when it is repeatedly used, a decrease in polishing characteristics occurs through a change in physical states (frictional force, zeta potential, pH, etc.) from initial ones. Particularly, a decrease in a removal rate is remarkable. It is necessary to replace the polishing agent whose polishing characteristics are decreased through the repeated uses to a certain degree, with a new polishing agent. The replacement of the polishing agent causes a problem of increasing production costs, such as a decrease in production efficiency induced by discontinuation of the polishing step for the replacement work and the like, in addition to preparation of the new polishing agent.

Therefore, contrivance is made for lengthening the life of the polishing agent by suppressing the decrease in the polishing characteristics such as the removal rate induced by the repeated uses. Specifically, it is effective to add a solution of an inorganic alkali such as potassium hydroxide or sodium hydroxide or an organic alkali solution such as an alcohol solution of an amine compound to the polishing agent in cycles as needed or to add a new polishing agent itself (see, e.g., Patent Documents 1 and 2).

However, in the case where the above inorganic or organic alkali solution is added, variation in pH can be suppressed but an effect for suppressing the decrease in the removal rate is little. Moreover, in the case where a new slurry itself is added as needed, there is a problem of increasing polishing costs.

### BACKGROUND ART DOCUMENT

### Patent Document

Patent Document 1: JP-A-2008-192656
Patent Document 2: Japanese Patent No. 4179448

### SUMMARY OF THE INVENTION

### Problems that the Invention is to Solve

An object of the invention is to provide an additive for a polishing agent, which is capable of suppressing a decrease in polishing characteristics of the polishing agent, particularly a removal rate, by adding the additive to a polishing agent to be repeatedly used, as needed during repeated uses.

Another object of the invention is to provide a polishing method using a polishing agent to be repeatedly used, which is capable of suppressing a decrease in polishing characteristics of the polishing agent, particularly a removal rate.

### Means for Solving the Problems

The invention provides an additive for a polishing agent and a polishing method, which have the following constitutions.

[1] An additive for a polishing agent including polishing-assistant particles, which is added, to a polishing agent which is repeatedly used for polishing a surface to be polished of a single-crystal substrate and contains at least one kind of an abrasive whose initial content before use is from 2 to 40% by mass based on a total amount of the polishing agent, in a state that the polishing agent contains a polished matter of the single-crystal substrate after the polishing agent is at least once used for polishing,

wherein an average primary particle size of the polishing-assistant particles is from 0.04 to 0.34 times an average primary particle size of a maximum particle size abrasive having a maximum average primary particle size in the abrasive, and a content of the polishing-assistant particles in the additive is such a content that the content of the polishing-assistant particles based on the total amount of the polishing agent in the polishing agent after the additive is added to the polishing agent in a predetermined amount becomes from 0.05 to 20 times the initial content of the abrasive in the polishing agent.

[2] The additive for a polishing agent according to [1], wherein the polishing-assistant particles are oxide fine particles.
[3] The additive for a polishing agent according to [1] or [2], wherein the polishing-assistant particles are selected from silicon oxide fine particles and tin oxide fine particles.
[4] The additive for a polishing agent according to any one of [1] to [3], wherein the polishing agent contains an abrasive obtained by combining first silicon oxide fine particles having an average primary particle size of 5 to 30 nm and second silicon oxide fine particles having an average primary particle size of 20 to 180 nm so that the average primary particle size of the first silicon oxide fine particles becomes smaller than the average primary particle size of the second silicon oxide fine particles, and water, and a ratio of the first silicon oxide fine particles to a total amount of the first silicon oxide fine particles and the second silicon oxide fine particles is from 0.7 to 70% by mass.
[5] The additive for a polishing agent according to any one of [1] to [4], wherein the initial content of the abrasive in the polishing agent is from 2 to 10% by mass based on the total amount of the polishing agent, the average primary particle size of the maximum particle size abrasive of the abrasive in the polishing agent is from 50 to 100 nm, and the average primary particle size of the polishing-assistant particles is from 0.05 to 0.32 times the average primary particle size of the maximum particle size abrasive.
[6] The additive for a polishing agent according to [5], wherein the average primary particle size of the polishing-assistant particles is from 0.06 to 0.29 times the average primary particle size of the maximum particle size abrasive.
[7] A polishing method comprising supplying a polishing agent to a polishing pad and bringing the polishing pad into contact with a surface to be polished of a single-crystal substrate that is an object to be polished to perform polishing by relative movement between both, wherein a polishing agent which contains at least one kind of an abrasive whose initial content before use is from 2 to 40% by mass based on a total amount of the polishing agent and which is repeatedly used, is used as the polishing agent, and the method includes the following steps (1) and (2):

(1) a step of polishing the surface to be polished at least once, using the polishing agent; and

(2) a step of adding, to the polishing agent after the step (1), an additive for a polishing agent, containing polishing-assistant particles whose average primary particle size is from 0.04 to 0.34 times an average primary particle size of a maximum particle size abrasive having a maximum average primary particle size in the abrasive, so that a content of the polishing-assistant particles based on the total amount of the polishing agent in the polishing agent after addition becomes from 0.05 to 20 times the initial content of the abrasive in the polishing agent.

[8] The polishing method according to [7], wherein the polishing agent is used in cycles by repeating an operation of recovering the polishing agent supplied to the polishing pad and used for polishing and again supplying the recovered polishing agent to the polishing pad, and the steps (1) and (2) are repeatedly performed in order.
[9] The polishing method according to [7] or [8], wherein a time at which the step (2) is performed is a time when polishing performance of the polishing agent after the step (1) is deteriorated as compared to initial polishing performance or as compared to polishing performance of the polishing agent immediately after the last step (2) in a case where the step (1) and the step (2) are repeatedly performed in order.

### Advantage of the Invention

According to the additive for a polishing agent of the invention, it is possible to suppress a decrease in polishing characteristics of the polishing agent, particularly a removal rate, by adding the additive to a polishing agent to be repeatedly used, as needed during repeated uses. The polishing method of the invention is a polishing method using a polishing agent to be repeatedly used, which is capable of suppressing a decrease in polishing characteristics of the polishing agent, particularly a removal rate.

### BRIEF DESCRIPTION OF THE DRAWINGS

FIG. 1 is a view showing an example of a polishing machine which can be used for a polishing method of the invention.

### MODE FOR CARRYING OUT THE INVENTION

Embodiments of the invention will be described below. Incidentally, the invention should not be construed as being limited to the following explanations.

In this specification, the average primary particle size of particles means an average primary particle size obtained by converting the specific surface area measured by a BET method unless otherwise stated. More specifically, the average primary particle size is one obtained by converting the specific surface area measured by a nitrogen adsorption BET method to the diameter of spherical particles.

### [Additive for Polishing Agent]

The additive for a polishing agent of the invention is an additive for a polishing agent, which is used for a polishing agent being repeatedly used for polishing a surface to be polished of a single-crystal substrate and containing at least one kind of an abrasive whose initial content before use is from 2 to 40% by mass based on a total amount of the polishing agent, and which is added in a state that the polishing agent contains a polished matter of the single-crystal substrate after the polishing agent is at least once used for polishing.

The additive for a polishing agent of the invention contains polishing-assistant particles and the average primary particle size of the polishing-assistant particles is from 0.04 to 0.34 times the average primary particle size of a maximum particle size abrasive having the maximum average primary particle size in the abrasive contained in the polishing agent.

Moreover, the content of the polishing-assistant particles in the additive for a polishing agent of the invention is such a content that the content of the polishing-assistant particles based on the total amount of the polishing agent in the polishing agent after the additive is added to the polishing agent in a predetermined amount is from 0.05 to 20 times the initial content of the abrasive in the polishing agent.

The abrasive having polishing ability against a single-crystal substrate, which is compounded with the polishing agent and used, has an average primary particle size having an appropriate size as mentioned later. Here, the above-mentioned abrasive contained in the polishing agent is known to aggregate by repeated uses. This is attributed to the phenomenon that a polished matter of the single-crystal substrate mixed into the polishing agent by the polishing operation attaches around the abrasive to play a role like a paste. Accordingly, when the additive for a polishing agent of the invention is added to add polishing-assistant particles having a sufficiently small average primary particle size as mentioned above and a large specific surface area as compared to the abrasive into the polishing agent in the above-mentioned ratio, the polished matter also attaches on the surface of the polishing-assistant particles, so that the amount attaching to the abrasive decreases and thus the suppression of the aggregation becomes possible. Furthermore, the adding amount of the additive for a polishing agent is controlled to such a degree that an adverse effect to be induced by an increase in the concentration of the polishing-assistant particles does not take place in the polishing agent after addition, and hence the effect for suppressing the aggregation of the abrasive is effectively exhibited.

Thus, the additive for a polishing agent of the invention can suppress the decrease in the polishing characteristics of the polishing agent, particularly the removal rate, by adding the additive to the polishing agent to be repeatedly used, as needed during repeated uses.

The following will describe the polishing agent to which the additive for a polishing agent of the invention is applied and whose object to be polished is a single-crystal substrate.

### (Polishing Agent)

The polishing agent to which the invention is applied is a polishing agent whose object to be polished is a single-crystal substrate and which is repeatedly used for polishing a surface to be polished thereof.

The single-crystal substrate is not particularly limited but particularly, the effect achieved by adding the additive for a polishing agent of the invention is remarkably expectable in a polishing agent whose object to be polished is a single-crystal substrate having a revised Mohs hardness of 10 or more.

Specifically, examples of the above-mentioned single-crystal substrate having a revised Mohs hardness of 10 or more include sapphire (α-Al₂O₃) substrates (hardness: 12), silicon carbide (SiC) substrates (hardness: 13), and gallium nitride (GaN) substrates (hardness: 13). Of these, as the polishing agent in which the additive for a polishing agent of the invention can particularly effectively act, a polishing agent for the sapphire substrates may be mentioned.

The polishing agent that is an object of the additive for a polishing agent of the invention is a polishing agent whose object to be polished is such a single-crystal substrate and which contains at least one kind of abrasive in which the content of the abrasive as an initial content before use is from 2 to 40% by mass based on the total amount of the polishing agent. Hereinafter, the content of the abrasive in the polishing agent shows an initial content before use unless otherwise stated.

The kind of the abrasive is not particularly limited as long as it is an abrasive usually used for a polishing agent to be repeatedly used for polishing of single-crystal substrates. Specifically, there may be mentioned fine particles of silicon oxide, cerium oxide, aluminum oxide, iron oxide, manganese oxide, titanium oxide, zirconium oxide, and the like. Of these, silicon oxide fine particles are preferred.

The polishing agent may contain one kind of an abrasive or may contain two or more kinds of abrasives. In this regard, in the polishing agent, it is preferred to compound two or more kinds of abrasives having different average primary particle sizes in combination. Here, in the case where two or more kinds of abrasives are used in combination, the range of 2 to 40% by mass based on the total amount of the polishing agent, which is a range of the content of the above abrasive, is a range of the total content of these two or more kinds of abrasives.

As the polishing agent that is an object of the additive for a polishing agent of the invention, in the case where the abrasive contained in the polishing agent is one kind, the average primary particle size of the abrasive is preferably from 20 to 180 nm, more preferably from 25 to 150 nm, particularly preferably from 50 to 100 nm, and most preferably from 60 to 90 nm. In the case where the polishing agent contains two or more kinds of abrasives having different average primary particle sizes as the abrasive, it is preferred that the average primary particle size of the abrasive having the largest average primary particle size among these abrasives falls within the above range. In this specification, the abrasive having the largest average primary particle size among the abrasives contained in the polishing agent is referred to as a maximum particle size abrasive. Moreover, in the case where the abrasive contained in the polishing agent is one kind as mentioned above, the maximum particle size abrasive means the one kind of the abrasive.

As shown below, in the additive for a polishing agent of the invention, the average primary particle size of the polishing-assistant particles to be compounded is selected on the basis of the average primary particle size of the maximum particle size abrasive contained in the polishing agent as an object. Therefore, in the invention, it is necessary to discriminate the average primary particle size of the maximum particle size abrasive contained in the polishing agent.

In the case where the polishing agent containing two or more kinds of abrasives having different average primary particle sizes is prepared by combining dispersions or the like each containing a single abrasive and is used for polishing, the average primary particle size of each abrasive can be confirmed beforehand, so that the abrasive having the largest average primary particle size among the abrasives to be combined can be taken as the maximum particle size abrasive.

Moreover, in the case where the polishing agent is supplied in a state that two or more kinds of abrasive having different average primary particle sizes are mixed, the maximum particle size abrasive is confirmed using particle size distribution obtained by analyzing the abrasives in the polishing agent by a dynamic light scattering method.

Specifically, in the case where one particle size peak is observed in the particle size distribution obtained from the analysis by the dynamic light scattering method, the abrasive having the peak is taken as the maximum particle size abrasive. In the case where a plurality of particle size peaks are observed, the abrasive having a particle size peak whose peak particle size is maximum is taken as the maximum particle size abrasive. In this case, the average primary particle size of the maximum particle size abrasive by the BET method is, for example, determined by determining relationship between analytic results of dispersions of a plurality of known single abrasives by the dynamic light scattering method and the average primary particle sizes by the BET method beforehand and corresponding the relationship to the particle size peak of the particle size distribution obtained by analyzing the polishing agent by the dynamic light scattering method.

As a preferred example of the polishing agent to which the invention is applied, there may be mentioned a polishing agent containing two kinds of silicon oxide fine particles having different average primary particle sizes. More specifically, there may be mentioned a polishing agent which contains, as the abrasive, an abrasive obtained by combining first silicon oxide fine particles having an average primary particle size of 5 to 30 nm and second silicon oxide fine particles having an average primary particle size of 20 to 180 nm so that the average primary particle size of the first silicon oxide fine particles is smaller than the average primary particle size of the second silicon oxide fine particles, and water, in which a ratio of the first silicon oxide fine particles to the total amount of the first silicon oxide fine particles and the second silicon oxide fine particles is from 0.7 to 70% by mass, and the total content of the first silicon oxide fine particles and the second silicon oxide fine particles is from 2 to 40% by mass based on the total amount of the polishing agent.

In the embodiment of the polishing agent containing the first silicon oxide fine particles and the second silicon oxide fine particles as the above-mentioned abrasive, the average primary particle size of the second silicon oxide fine particles is preferably from 25 to 150 nm, further preferably from 50 to 100 nm, and particularly preferably from 60 to 90 nm. Moreover, the average primary particle size of the first silicon oxide fine particles is preferably from 5 to 25 nm and more preferably from 10 to 20 nm. As the compounding ratio of the first silicon oxide fine particles and the second silicon oxide fine particles, the ratio of the first silicon oxide fine particles to the total amount of both particles is preferably from 2 to 70% by mass, more preferably from 3 to 60% by mass, and further preferably from 3 to 50% by mass.

In the above polishing agent, the first silicon oxide fine particles and the second silicon oxide fine particles are used as abrasives. By thus compounding two kinds of silicon oxide fine particles having different average primary particle sizes at the above-mentioned compounding ratio, a high removal rate is obtained.

In the polishing agent containing the first silicon oxide fine particles and the second silicon oxide fine particles as mentioned above, the second silicon oxide fine particles having a large average primary particle size is the maximum particle size abrasive, and in the case where the additive for a polishing agent of the invention is used for the polishing agent, the average primary particle size of the polishing-assistant particles to be compounded is prepared so as to fall within a range of 0.04 to 0.34 times the average primary particle size of the second silicon oxide fine particles.

Here, in the polishing agent containing two kinds of abrasives having different average primary particle sizes, it is considered that the high removal rate is obtained since the first silicon oxide fine particles having a small average primary particle size are appropriately present in the polishing agent independent of the second silicon oxide fine particles having a large average primary particle size. On the other hand, when such a polishing agent is repeatedly used, as mentioned above, the polished matter of a single-crystal substrate mixed in the polishing agent by the polishing operation attaches around the abrasive and plays a role like a paste to induce aggregation of the abrasive. In the case of the polishing agent containing two kinds of abrasives having different average primary particle sizes, due to this action, the first silicon oxide fine particles having a small average primary particle size further attaches to the second silicon oxide fine particles having a large average primary particle size, so that there also arises a problem of inhibiting the removal rate-improving effect owing to the independent presence of the first silicon oxide fine particles having a small average primary particle size.

When the additive for a polishing agent of the invention is added to the polishing agent in such a state, the polishing-assistant particles having an average primary particle size sufficiently smaller than the average primary particle size of the second silicon oxide fine particles function instead of the above first silicon oxide fine particles, so that the removal rate-improving effect can be restored. Also, in this case, the effect of reducing the amount of the polished matter attached to the abrasive owing to the attachment of the polished matter on the surface of the polishing-assistant particles to make the suppression of aggregation possible is the same as mentioned above.

In the above-mentioned polishing agent, the same silicon oxide fine particles except for having different average primary particle sizes can be used as the first silicon oxide fine particles and the second silicon oxide fine particles, and ones produced by various known methods can be used as both fine particles. Examples thereof include silicon oxide fine particles such as colloidal silica obtained by subjecting fumed silica or sodium silicate synthesized in a vapor phase from silicon tetrachloride in flame of oxygen and hydrogen to ion exchange or desalination after neutralization, or colloidal silica obtained by hydrolysis of a silicon alkoxide in a liquid phase. Of these, colloidal silica in which sodium silicate is used as a starting material is more preferred, from the viewpoint of the diversity of varieties. Incidentally, in the above-mentioned polishing agent containing one kind of an abrasive, the same shall apply also in the case where silicon oxide fine particles are used.

The content of the abrasive in the polishing agent to which the invention is applied, or in the case where two or more kinds of abrasives are contained, the content of the abrasives as the total content is preferably from 2 to 40% by mass, preferably from 2 to 28% by mass, and more preferably from 2 to 10% by mass based on the total amount of the polishing agent. When the content of the abrasive in the polishing agent is less than 2% by mass based on the total amount of the polishing agent, a sufficient removal rate is sometimes not obtained, whereas when it exceeds 40% by mass, an improvement of the removal rate corresponding to an increase in abrasive concentration is not observed, and further, the viscosity of the polishing agent is excessively increased to enhance gelation of the polishing agent, in some cases.

The polishing agent to which the invention is applied contains water besides the above-mentioned abrasive. Water is a medium for dispersing abrasives, e.g., the above-mentioned first silicon oxide fine particles and second silicon oxide fine particles, and for dispersing and dissolving other optional components added as needed. Water is not particularly limited but, in view of influences on other compounding components, contamination of impurities and influences on the pH and the like, pure water or deionized water is preferred. Water has a function of controlling fluidity of the polishing agent, so that the content thereof can be appropriately set according to intended polishing characteristics such as the removal rate and flattening characteristics.

In the polishing agent to which the invention is applied, water is preferably contained within the range of 60 to 98% by mass based on the total amount of the polishing agent. When the content of water is less than 60% by mass based on the total mass of the polishing agent, the viscosity of the polishing agent is increased to impair the fluidity in some cases, whereas when the content thereof exceeds 98% by mass, the concentration of the above-mentioned first silicon oxide fine particles and second silicon oxide fine particles as the polishing abrasives is sometimes decreased to fail to obtain a sufficient removal rate.

The polishing agent to which the invention is applied can be prepared by weighing an abrasive which is contained as an essential component, for example, the above-mentioned first silicon oxide fine particles and second silicon oxide fine particles and water, for example, so as to achieve the above-mentioned compounding amount, and mixing them.

Here, when colloidal silica is used as abrasive, for example, as both the first silicon oxide fine particles and the second silicon oxide fine particles, because colloidal silica is supplied in a state where the silicon oxide fine particles are previously dispersed in water, it is used as it is or the polishing agent can be prepared only by appropriately diluting it with water or mixing colloidal silica containing the above-mentioned first silicon oxide fine particles and colloidal silica containing the above-mentioned second silicon oxide fine particles at a desired ratio and appropriately diluting the mixture with water.

Incidentally, in addition to the abrasive and water, one or plural kinds of optional components as contained in normal polishing agent for chemical mechanical polishing may be allowed to be contained in the polishing agent to which the invention is applied within the range not impairing the above-mentioned effects of the invention. Examples of the optional components include a pH adjuster for the polishing agent, a buffering agent, a chelating agent, a lubricant, a dispersing agent for polishing particles, and a biocide.

Of the optional components compounded as the pH adjuster and the buffering agent, as acids, there can be used inorganic acids such as nitric acid, sulfuric acid, phosphoric acid and hydrochloric acid; saturated carboxylic acids such as formic acid, acetic acid, propionic acid and butyric acid; hydroxy acids such as lactic acid, malic acid and citric acid; aromatic carboxylic acids such as phthalic acid and salicylic acid; dicarboxylic acids such as oxalic acid, malonic acid, succinic acid, glutaric acid, adipic acid, fumaric acid and maleic acid; amino acids such as glycine and alanine; and organic acids such as heterocyclic carboxylic acids. As basic compounds, there can be used ammonia; lithium hydroxide; potassium hydroxide; sodium hydroxide; quaternary ammonium compounds such as tetramethylammonium; and organic amines such as methylamine, dimethylamine, trimethylamine, ethylamine, diethylamine, triethylamine, n-propylamine, di-n-propylamine, tri-n-propylamine, isopropylamine, n-butylamine, isobutylamine, sec-butylamine, tert-butylamine, valerylamine, isovalerylamine, cyclohexylamine, benzylamine, α-phenylethylamine, β-phenylethylamine, ethylenediamine, trimethylenediamine, tetramethylenediamine, pentamethylenediamine, hexamethylenediamine, tetramethylenediamine hydroxide, aniline, methylaniline, dimethylaniline, o-toluidine, m-toluidine, p-toluidine, o-anisidine, m-anisidine, p-anisidine, m-chloroaniline, p-chloroaniline, o-nitroaniline, m-nitroaniline, p-nitroaniline, 2,4-dinitroaniline, picramide, o-phenylenediamine, m-phenylenediamine, p-phenylenediamine, benzidine, sulfanilic acid, acetamidine, 2-anilinoethanol, anilinophenol, aminoacetanilide, aminoacetophenone, 2-aminoethanol, 2-aminoethanethiol, 2-amimo-2-ethyl-1,3-propanediol, aminoguanidine, 5-amino-o-cresol, 6-amino-m-cresol, ethyl 3-aminocrotonate, p-aminostyrene, 4-amino-1,2,4-triazole1,4-amino-1-naphthol, 5-amino-2-naphthol, 8-amino-2-naphthol, 8-amino-1-naphthol, aminophenol, 2-amino-1-butanol, 2-amino-1-propanol, α-aminopropionitrile, p-aminobenzyl alcohol, p-aminobenzaldehyde, 2-amino-2-methyl-1-propanol, 2-amino-2-methyl-1,3-propanediol, 4-amino-4-methyl-2-pentanone, allantoin, allylamine, arecaidine, arecoline, p-isopropylaniline, 2-(ethylamino)-ethanol, N-ethyl-1-naphthylamine, N-ethyl-2-naphthylamine, O-ethylhydroxylamine, N-ethylbenzamide, ephedrine, oxamic acid, xylidine, p-xylene-α, α′-diamine, quinuclidine, kinetin, quinoxaline, 2-quinolylamine, 4-quinolylamine, glycocyamidine, 3,6-diazaoctane-1,8-diamine, 4,4′-diphenylamine, 2,4-diaminophenol, 3,4-diaminophenol, diisopropylamine, diethanolamine, 2-(diethylamino)-ethanol, diethylcyanamide, diethylenetriamine, cyclopropylamine, cyclohexanediamine, N,N′-diphenylethylenediamine, N,N′-diphenylguanidine, 4,4′-diphenylmethanediamine, 2-dimethylaminoethanol, N,N-dimethyl-2-naphthylamine, 3,5-dimethylpyrazole, dimethylpyridine, N,N-dimethyl-p-phenylenediamine, 2-thiazoleamine, thymylamine, thymine, decahydroquinoline, tetraethylammonium, 1,2,3,4-tetrahydro-1-naphthylamine, 1,2,3,4-tetrahydronaphthylamine, N,N,N′,N′-tetramethylethylenediamine, N,N,N′,N′-tetramethyl-p-phenylenediamine, 1,4-butanediamine, 2,4,6-triaminophenol, triethanolamine, trimethylamine oxide, 2,3-toluenediamine, 2,4-toluenediamine, 2,6-toluenediamine, 3,5-toluenediamine, 1,2-naphthalenediamine, 1,4-naphthalenediamine, 1,8-naphthalenediamine, 2,6-naphthalenediamine, 2,7-naphthalenediamine, 4,4′-bis(dimethylamino)diphenylamine, bis(dimethylamino)methane, histamine, N,N-bis(2-hydroxyethyl)butylamine, vinylamine, 4-biphenylylamine, piperazine, 2,5-piperazinedione, 2-piperidinone, piperidine, 2-pyridylamine, 3-pyridylamine, 4-pyridylamine, pyridine, pyrimidine, pyrrolidine, pyrroline, phenacylamine, N-phenylhydroxylamine, 1-phenyl-2-propaneamine, o-phenylenediamine, m-phenylenediamine, p-phenylenediaminc, phenethylamine, 1,4-butanediamine, 1,2-propanediamine, 1,3-propanediamine, hexamethylenetetramine, 1,6-hexamethylenediamine, N-benzylhydroxylamine, O-benzylhydroxylamine, benzhydrylamine, 1,2,3-benzenetriamine, 1,2,4-benzenetriamine, 1,5-pentanediamine, tert-pentylamine, methylguanidine, N-methylhydroxylamine, O-methylhydroxylamine, 2-methylpiperidine, 3-methylperidine, 4-methylpiperidine, N-methylpiperidine, 2-methylpyridine, 3-methylpyridine, 4-methylpyridine, N-methyl-p-phenylenediamine, 4-methoxypyridine, kanosamine, galactosamine, glucosamine, fusacosamine, mannosamine, N-methylglucosamine, muramic acid, monoethanolamine, ethylethanolamine, diethanolamine, and propylenediamine. In addition, they may be derivatives in which one or two or more of protons of the above-mentioned compounds are substituted by atoms or atomic groups such as F, Cl, Br, I, OH, CN, and NO₂.

Examples of the chelating agents include amino acids such as glycine and alanine, polyaminocarboxylic acid-based chelate compounds and organic phosphonic acid-based chelate compounds. Specifically, ethylenediaminetetraacetic acid, nitrilotriacetic acid, diethylenetriaminepentaacetic acid, hydroxyethylethylenediaminetriacetic acid, triethylenetetraminehexaacetic acid, 1,3-propanediaminetetraacetic acid, 1-hydroxyethane-1,1-diphosphonic acid, nitrilotris(methylenephosphonic acid), diethylenetriaminepentamethylenephosphonic acid, phosphonobutanetricarboxylic acid, phosphonohydroxyacetic acid, hydroxyethyldimethylenephosphonic acid, aminotrismethylenephosphonic acid, ethylenediaminetetramethylenephosphonic acid, hexamethylenediaminetetramethylenephosphonic acid, phytic acid and the like may be mentioned.

As the above-mentioned lubricants and dispersing agents for polishing particles, there can be used anionic, cationic, nonionic or amphoteric surfactants, polysaccharides, water-soluble polymers and the like.

As the surfactants, there can be used compounds each having an aliphatic hydrocarbon group or an aromatic hydrocarbon group as a hydrophobic group, having a group in which at least one of linking groups such as an ester, an ether and an amide and connecting groups such as an acyl group and an alkoxyl group is introduced into the hydrophobic group, and having a group derived from a carboxylic acid, a sulfonic acid, a sulfate ester, phosphoric acid, a phosphate ester or an amino acid, as a hydrophilic group.

As the polysaccharides, there can be used alginic acid, pectin, carboxymethylcellulose, curdlan, pullulan, xanthan gum, carrageenan, gellan gum, locust bean gum, gum arabic, tamarind, psyllium and the like.

As the water-soluble polymers, there can be used polyacrylic acid, polyvinyl alcohol, polyvinyl pyrrolidone, polymethacrylic acid, polyacrylamide, polyaspartic acid, polyglutamic acid, polyethyleneimine, polyallylamine, polystyrenesulfonic acid, polyethylene glycol and the like.

### (Additive for Polishing Agent)

The additive for a polishing agent of the invention is an additive for a polishing agent, which is added to the polishing agent which is repeatedly used for polishing the above-mentioned single-crystal substrate, in a state that the polishing agent contains a polished matter of the single-crystal substrate after the polishing agent is at least once used for polishing.

The additive for a polishing agent of the invention contains polishing-assistant particles having the following average primary particle size. Namely, with regard to the average primary particle size of the polishing-assistant particles, when the average primary particle size of the maximum particle size abrasive contained in the polishing agent to be an object of use is taken as (A) and the average primary particle size of the polishing-assistant particles is taken as (B), a ratio of the average primary particle size of the polishing-assistant particles to the average primary particle size of the maximum particle size abrasive, represented by (B)/(A), is from 0.04 to 0.34. When (B)/(A) is less than 0.04, the polishing-assistant particles become far smaller than the polishing agent, so that the polishing-assisting effect is little, whereas when it exceeds 0.34, the polishing-assistant particles themselves counteract the polishing effect of the polishing agent, so that the polishing-assistant particles sometimes do not function as a polishing assistant.

In the case where the additive for a polishing agent of the invention is used for the polishing agent in which the abrasive contained in the polishing agent exemplified as the above-mentioned polishing agent is one kind and the average primary particle size of the abrasive is from 20 to 180 nm, the average primary particle size of the polishing-assistant particles contained in the additive for a polishing agent can be set to from 0.8 to 61.2 nm. In this case, the average primary particle size of the polishing-assistant particles is preferably from 5 to 60 nm, and more preferably from 5 to 45 nm. Moreover, for example, in the case where the additive for a polishing agent is used for the polishing agent containing the first silicon oxide fine particles having an average primary particle size of 5 to 30 nm and the second silicon oxide fine particles having an average primary particle size of 20 to 180 nm as the abrasive, as the average primary particle size of the polishing-assistant particles contained in the additive for a polishing agent, the polishing agent containing one kind of the abrasive having an average primary particle size of 20 to 180 nm as mentioned above can be used.

Here, with regard to the ratio of the average primary particle size of the polishing-assistant particles to the average primary particle size of the maximum particle size abrasive, which is represented by the above-mentioned (B)/(A), a preferable range thereof varies depending on the average primary particle size of the maximum particle size abrasive contained in the polishing agent to be an object and the initial content of the abrasive in the polishing agent.

As the polishing agent in which the effect of suppressing the decrease in polishing characteristics of the polishing agent, particularly the removal rate can be more remarkably exhibited by adding, to the polishing agent to be repeatedly used, the additive for a polishing agent of the invention as needed during repeated uses, there may be mentioned a polishing agent in which the average primary particle size of the maximum particle size abrasive is from 50 to 100 nm and the initial content of the abrasive is from 2 to 10% by mass. Further, in the additive for a polishing agent of the invention, the effect is particularly remarkable for the polishing agent in which the initial content of the polishing agent is the same as mentioned above and the average primary particle size of the maximum particle size abrasive is from 60 to 90 nm.

In the case where the additive for a polishing agent of the invention is used for such a polishing agent in which the average primary particle size of the maximum particle size abrasive is from 50 to 100 nm and the initial content of the abrasive is from 2 to 10% by mass, as the ratio of the average primary particle size of the polishing-assistant particles to the average primary particle size of the maximum particle size abrasive, (B)/(A), a range of 0.04 to 0.34 is applied as mentioned above, and the ratio is suitably from 0.05 to 0.32, and particularly preferably from 0.06 to 0.29. In such an embodiment, the average primary particle size of the polishing-assistant particles contained in the corresponding additive for a polishing agent is from 2 to 34 nm, from 2.5 to 32 nm, and from 3 to 29 nm, respectively. In the above embodiment, a further preferable range of the average primary particle size of the polishing-assistant particles contained in the additive for a polishing agent is from 5 to 25 nm.

Moreover, also with regard to the polishing agent to be used in this embodiment, a polishing agent containing two kinds of silicon oxide fine particles having different average primary particle sizes as the abrasive is preferred. More specifically, there may be mentioned a polishing agent which contains first silicon oxide fine particles having an average primary particle size of 5 to 30 nm and second silicon oxide fine particles having an average primary particle size of 50 to 100 nm and water and in which a ratio of the first silicon oxide fine particles to the total amount of the first silicon oxide fine particles and the second silicon oxide fine particles is from 0.7 to 70% by mass and the total content of the first silicon oxide fine particles and the second silicon oxide fine particles is from 2 to 10% by mass based on the total amount of the polishing agent.

The kind of the polishing-assistant particles is not particularly limited as long as the particles are particles in which the average primary particle size thereof converted from the specific surface area by the BET method falls within the above-mentioned range of the invention, the particles do not influence the dispersion state of the abrasive at the time when added to the polishing agent to be an object of addition, and the particles themselves can retain a dispersion state. The shape of the particles is a spherical shape, a needle shape, a plate shape, beads, and the like and is not particularly limited but, in view of maintaining the removal rate and suppressing scratches on the substrate surface, a spherical shape is preferred.

As the kind of the particles, oxide fine particles are preferred. Specifically, there may be mentioned fine particles selected from silicon oxide, tin oxide, cerium oxide, aluminum oxide, titanium oxide, manganese oxide, iron oxide, zirconium oxide, and the like. One kind of them may be used singly or two or more kinds thereof may be used in combination. Of these, in the invention, silicon oxide fine particles or tin oxide fine particles are preferred and silicon oxide fine particles are more preferred. The same silicon oxide fine particles as described in the above-mentioned abrasive except for having different average primary particle sizes can be used as the silicon oxide fine particles, and colloidal silica in which sodium silicate is used as a starting material is more preferred, from the viewpoint of the diversity of varieties.

The content of the polishing-assistant particles in the additive for a polishing agent of the invention is such a content that the content of the polishing-assistant particles based on the total amount of the polishing agent in the polishing agent after the polishing-assistant particles are added to the polishing agent to be an object of addition in a predetermined amount becomes from 0.05 to 20 times the initial content of the abrasive in the above-mentioned polishing agent.

The additive for a polishing agent may be, for example, constituted by the polishing-assistant particles alone as long as the additive for a polishing agent is an additive for a polishing agent, which is capable of homogeneous dispersion of the polishing-assistant particles at the time when the additive is added to the above-mentioned polishing agent to be an object of addition. However, since it is difficult to add the additive in such a manner, the additive for a polishing agent is usually prepared as a dispersion of the polishing-assistant particles. The dispersion medium to be used for dispersing the polishing-assistant particles is not particularly limited as long as it is a dispersion medium capable of satisfactorily dispersing the polishing-assistant particles and retaining the stable dispersion of the polishing-assistant particles and the abrasive at the time when the additive is added to the polishing agent and is a dispersion medium which does not influence the polishing characteristics of the polishing agent. Preferably, there may be mentioned the same dispersion medium as that contained in the polishing agent to be an object of addition, specifically water.

The additive for a polishing agent is preferably constituted by the polishing-assistant particles and water. In this case, the content of the polishing-assistant particles in the additive for a polishing agent is not particularly limited as long as it is a content falling within the range where the above requirements are satisfied and capable of retaining a good dispersion state. Specifically, the content of the polishing-assistant particles in the additive for a polishing agent of the invention is preferably from 1 to 50% by mass, and preferably from 20 to 40% by mass based on the total amount of the additive for a polishing agent.

When the content of the polishing-assistant particles based on the total amount of the additive for a polishing agent is less than 1% by mass, the amount of the dispersion medium carried in together increases at the time when the additive is added to the polishing agent in such an amount that the content of the polishing-assistant particles based on the total amount of the polishing agent in the polishing agent after addition becomes 0.05 times or more the initial content of the abrasive in the polishing agent, and thus the content of the abrasive in the polishing agent after addition is decreased to such a degree that the polishing characteristics are influenced, so that the case is not preferred. On the other hand, when the content of the polishing-assistant particles based on the total amount of the additive for a polishing agent exceeds 50% by mass, the polishing-assistant particles aggregate one another and thus stable existence thereof becomes difficult, so that the case is not preferred.

Incidentally, with regard to the content of the abrasive in the polishing agent after the addition of the additive for a polishing agent, it is necessary to keep 2.0% by mass or more based on the total amount of the polishing agent after addition, and the content is preferably 2.5% by mass or more, and more preferably 3.0% by mass or more. Moreover, the lower limit of the content of the abrasive in the polishing agent after the addition of the additive for a polishing agent is the same also in the case where the repeated uses of the polishing agent and the addition of the additive for a polishing agent are repeatedly performed.

Here, when the additive for a polishing agent is added to the polishing agent, the content ratio of the abrasive is considered to decrease in the polishing agent after the addition. However, it is confirmed that, when the polishing agent is repeatedly used, water contained therein is vaporized to increase the content ratio of the abrasive. Therefore, even when the addition of the additive for a polishing agent is repeatedly performed in the invention, the content ratio of the abrasive in the polishing agent is substantially not decreased and it is possible to maintain the above-mentioned range.

The additive for a polishing agent can be prepared by weighing polishing-assistant particles which are contained as an essential component and a disperson medium, preferably water, for example, so as to achieve the above-mentioned compounding amount, and mixing them.

Here, when colloidal silica is used as the polishing-assistant particles, since the colloidal silica is supplied in a state where the silicon oxide fine particles are previously dispersed in water, it is used as it is or the additive for a polishing agent can be prepared only by appropriately diluting it with water.

Incidentally, in addition to the polishing-assistant particles, one or plural kinds of optional components as contained in the above-mentioned polishing agent may be allowed to be contained in the additive for a polishing agent of the invention within the range not impairing the above-mentioned effects of the invention. The optional components include, for example, a pH adjuster for the polishing agent, a buffering agent, a chelating agent, a lubricant, a dispersing agent for polishing particles, a biocide, and the like. With regard to specific embodiments, the same shall apply as in the above-mentioned polishing agent.

The additive for a polishing agent of the invention is added, after the above-mentioned polishing agent is at least once used for polishing a surface to be polished of a single-crystal substrate, in a state that the polishing agent contains a polished matter of the single-crystal substrate. The method of adding the additive for a polishing agent to the polishing agent is not particularly limited as long as it is a method capable of homogeneously mixing the additive for a polishing agent into the polishing agent. A specific method will be described in the following polishing method.

The adding amount of the additive for a polishing agent to the above-mentioned polishing agent to be an object is such an adding amount that, in the case where the initial content of the abrasive in the polishing agent is taken as (X) and the content of the above-mentioned polishing-assistant particles based on the total amount of the polishing agent in the polishing agent after the additive for a polishing agent is added is taken as (Y), a ratio of the content of the polishing-assistant particles in the polishing agent after the addition of the additive for a polishing agent to the initial content of the abrasive in the polishing agent, which is represented by (Y)/(X), becomes from 0.05 to 20. The adding amount of the additive for a polishing agent is preferably such an amount that the value of the above-mentioned (Y)/(X) becomes from 0.05 to 2.5, more preferably such an amount that the value becomes from 0.05 to 1.5.

With regard to the adding amount of the additive for a polishing agent to the above-mentioned polishing agent to be an object, when the value of (Y)/(X) is less than 0.05, the effect of restoring the polishing characteristics of the polishing agent is not sufficient, whereas when the value exceeds 20, the existing ratio of the polishing agent decreases and the polishing agent does not function as a polishing agent.

Thus, it becomes possible to use the polishing agent which is at least once used for polishing a surface to be polished of a single-crystal substrate and to which the additive for a polishing agent of the invention is added under the above-mentioned addition conditions in a state that the polishing agent contains a polished matter of the single-crystal substrate, as a polishing agent in which the polishing characteristics, particularly the removal rate is regenerated to a level equal to or higher than the initial level.

Here, the time at which the additive for a polishing agent of the invention is added to the polishing agent is preferably a time at which the polishing characteristics of the polishing agent is begun to decrease owing to repeated uses. A specific degree of the decrease in the polishing characteristics at the time when the additive for a polishing agent is added is appropriately selected depending on the kinds of the single-crystal substrate as an object to be polished and the surface to be polished, required accuracy, productivity and the like. For example, there may be mentioned a time for addition at which the removal rate is decreased to 50 to 85% of the initial rate. Moreover, the period from the start of polishing until the polishing characteristics are begun to decrease varies depending on the kind of the single-crystal substrate, the kind of the polishing agent, polishing conditions and the like. When the additive for a polishing agent is added to the polishing agent before the decrease in the polishing characteristics, the effect of the addition is sometimes not sufficiently exhibited.

In this regard, the change of the polishing characteristics can be confirmed by monitoring actual polishing performance such as the removal rate, temperature of polishing platen and polishing pad, friction, a torque value of a polishing machine motor and the like. Alternatively, the polishing characteristics can be evaluated by confirming the aggregation state of the polishing agent using measurement of particle size distribution by a dynamic light scattering method, a light-shielding coarse particle measurement apparatus and the like. Furthermore, measuring the content of the polished matter of the single-crystal substrate contained in the polishing agent after use as a measure by pH measurement or the like, the time for adding the additive for a polishing agent may be selected using the content as an index.

The number of times of addition of the additive for a polishing agent of the invention to the polishing agent may be once for the polishing agent to be an object. However, the addition may be performed plural times such that, after the first addition, second addition is performed to the polishing agent at the time when the polishing characteristics are decreased by repeated uses of the polishing agent after the addition and thereafter the same operations of polishing and addition are repeatedly performed continuously. In this case, preferred is a method of repeating a cycle of the repeated uses (polishing) of the polishing agent and the addition of the additive for a polishing agent at the time when the polishing characteristics is decreased, while monitoring the polishing characteristics of the polishing agent.

The addition conditions for the addition of the additive for a polishing agent at the second time or later in this case can be set in the same manner as in the case of the first time. However, in this case, the amount of the polishing-assistant particles added to the polishing agent before the addition should not be considered. Specifically, the adding amount is such an amount that a ratio of the content (Xn) of the polishing-assistant particles added by the addition (addition at n-th time) in the polishing agent after the addition of the additive for a polishing agent to the initial content (Y) of the abrasive in the polishing agent becomes from 0.05 to 20. This means that, when the additive for a polishing agent is the same, the additive for a polishing agent is added to the polishing agent in the same adding amount at all the time from first time to n-th time and the effect is explained as follows.

The polishing-assistant particles added to the polishing agent by the additive for a polishing agent of the invention have a sufficiently small average primary particle size as compared to the average primary particle size of the maximum particle size abrasive as mentioned above and, through the attachment of the polished matter on the surface of the polishing-assistant particles, the amount attached to the abrasive decreases, so that the effect of achieving the suppression of aggregation is exhibited.

In the polishing agent, the polishing-assistant particles retain a dispersed state independent of the abrasive immediately after the addition. However, when the polishing agent is used and the polished matter is attached, the polishing-assistant particles has a low existence probability as compared to the abrasive, so that the attachment of the polishing-assistant particles to the abrasive including the maximum particle size abrasive is mainly conducted rather than the aggregation of the polishing-assistant particles themselves. As a result, an amount of the independently existing polishing-assistant particles having a small average primary particle size remarkably decreases. Thereby, as explained above, the removal rate restored by the addition of the polishing-assistant particles having a small average primary particle size is again decreased.

That is, it is considered that there is observed a correlation between the amount of the independently existing polishing-assistant particles in the polishing agent and the removal rate. Therefore, in the invention, in order to keep the amount of the independently existing polishing-assistant particles having a small average primary particle size in the polishing agent, the amount of the polishing-assistant particles consumed through the attachment thereof to the abrasive having a large average primary particle size with the progress of polishing is compensated at every time when the removal rate of the polishing agent is decreased. Thereby, it becomes possible to maintain the polishing characteristics of the polishing agent to be repeatedly used, particularly the removal rate.

As a method of applying the additive for a polishing agent of the invention to polishing of a surface to be polished of a single-crystal substrate in which a polishing agent is repeatedly used, specifically, the following polishing method of the invention may be mentioned.

### [Polishing Method]

The polishing method of the invention is a polishing method comprising supplying a polishing agent to a polishing pad and bringing the polishing pad into contact with a surface to be polished of a single-crystal substrate that is an object to be polished to perform polishing by relative movement between both, wherein a polishing agent which contains at least one kind of abrasive whose initial content before use is from 2 to 40% by mass based on the total amount of the polishing agent and which is repeatedly used, is used as the polishing agent, and the method includes the following steps (1) and (2).

(1) A step of polishing the above-mentioned surface to be polished at least once, using the above-mentioned polishing agent (hereinafter sometimes referred to as “polishing step”).

(2) A step of adding, to the polishing agent after the step (1), an additive for a polishing agent, containing polishing-assistant particles whose average primary particle size is from 0.04 to 0.34 times the average primary particle size of a maximum particle size abrasive having the maximum average primary particle size in the abrasive so that the content of the polishing-assistant particles based on the total amount of the polishing agent in the polishing agent after addition becomes from 0.05 to 20 times the initial content of the abrasive in the polishing agent (hereinafter sometimes referred to as “addition step”).

The single-crystal substrates to which the polishing method of the invention is applied are the same as those described in the above including preferred embodiments. The polishing agent to be used in the polishing method of the invention is also the same as one described in the above including preferred embodiments. Moreover, with regard to the additive for a polishing agent to be used in the polishing method of the invention, the additive for a polishing agent of the invention as mentioned above can be used.

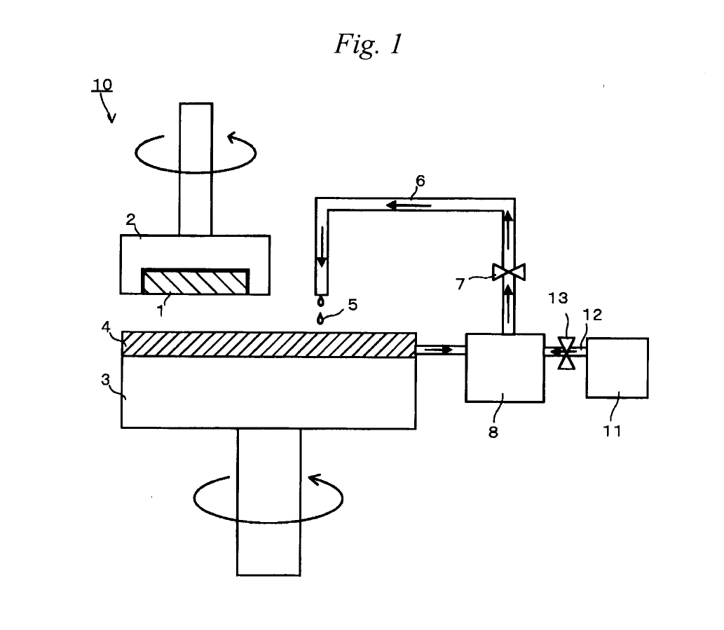

In the above-mentioned polishing method, a conventionally known polishing machine can be used as a polishing machine. An example of a polishing machine which can be used in embodiments of the invention, in which the polishing agent is used in cycles, and which is constituted in such a manner that the addition of the additive to the polishing agent is possible is shown in FIG. 1 and described below. However, the polishing machine used in the embodiments of the invention should not be construed as being limited to one having such a structure.

This polishing machine 10 is provided with a polishing head 2 for holding an object to be polished (single-crystal substrate) 1, a polishing platen 3, a polishing pad 4 stuck onto a surface of the polishing platen 3, a polishing agent tank 8 for storing an polishing agent 5 and a polishing agent supply tube 6 for supplying the polishing agent 5 from the polishing agent tank 8 to the polishing pad 4 using a polishing agent supply means 7. Furthermore, the machine is provided with a tank 11 of the additive for a polishing agent for storing the additive for a polishing agent and a supply tube 12 of the additive for a polishing agent for supplying the additive for a polishing agent from the tank 11 of the additive for a polishing agent to the polishing agent tank 8 using a supply means 13 of the additive for a polishing agent. The following will describe each step with reference to an example in the case where the polishing method of the invention is performed using such a polishing machine 10.

### (Step (1))

The step (1) is a step of polishing the surface to be polished of the single-crystal substrate that is an object to be polished at least once, using the polishing agent to be repeatedly used.

The mechanism of repeated uses of the polishing agent in the polishing machine 10 is first described. The polishing machine 10 is constituted in such a manner that the surface to be polished of the object to be polished (single-crystal substrate) 1 held by the polishing head 2 is brought into contact with the polishing pad 4, while supplying the polishing agent 5 from the polishing agent supply tube 6, and that the polishing head 2 and the polishing platen 3 are relatively rotated to perform polishing. In addition, the polishing machine 10 is constituted in such a manner that it has a recovery means (not shown in the figure) for recovering the polishing agent 5 used for polishing from the polishing pad 4, and that the polishing agent 5 recovered is transferred to the polishing agent tank 8. The polishing agent 5 which has returned to the polishing agent tank 8 is supplied again to the polishing pad 4 through the polishing agent supply tube 6 using the polishing agent supply means 7. In this way, the polishing agent 5 is used in cycles. Incidentally, polishing of the surface to be polished of the object to be polished (single-crystal substrate) 1 is specifically performed as follows.

Using such a polishing machine 10, the surface to be polished of the object to be polished (single-crystal substrate) 1 can be polished. Here, the polishing machine 10 is a polishing machine which polishes one surface of the object to be polished (single-crystal substrate) as the surface to be polished. For example, however, it is also possible to polish the surfaces to be polished (both surfaces) of the object to be polished (single-crystal substrate), using a double-sided simultaneous polishing machine in which the same polishing pads as used in the polishing machine 10 are disposed on upper and lower surfaces of the object to be polished (single-crystal substrate).

The polishing head 2 may perform not only rotation movement but also linear movement. Further, the polishing platen 3 and the polishing pad 4 may have a size equivalent to or less than that of the object to be polished (single-crystal substrate) 1. In that case, it is preferred to relatively move the polishing head 2 and the polishing platen 3, thereby making it possible to polish the entire surface of the surface to be polished of the object to be polished (single-crystal substrate) 1. Furthermore, the polishing platen 3 and the polishing pad 4 may not perform rotation movement, but may move, for example, in one direction by a belt system.

Although there is no particular limitation on polishing conditions of such a polishing machine 10, it is also possible to more increase the polishing pressure and to improve the removal rate by applying a load to the polishing head 2 to press it against the polishing pad 4. The polishing pressure is preferably from about 10 to 50 kPa and, from the viewpoints of uniformity of the removal rate in the surface to be polished of the object to be polished (single-crystal substrate) 1, flatness and prevention of polishing defects such as scratches, it is more preferably from about 10 to 40 kPa. The number of rotations of the polishing platen 3 and the polishing head 2 is preferably from about 50 to 500 rpm, but is not limited thereto. Moreover, the amount of the polishing agent 5 supplied is appropriately adjusted and selected by a constituent material of the surface to be polished, a composition of the polishing agent, the above-mentioned polishing conditions and the like. However, for example, when a wafer having a diameter of 50 mm is polished, the amount thereof supplied is preferably from approximately 5 to 300 cm³/min.

As the polishing pad 4, there can be used one made of a usual nonwoven, a foamed polyurethane, a porous resin, a non-porous resin or the like. Further, in order to accelerate the supply of the polishing agent 5 to the polishing pad 4 or to allow a certain amount of the polishing agent 5 to stay in the polishing pad 4, lattice-shaped, concentric or helical grooves may be processed on a surface of the polishing pad 4.

Furthermore, a pad conditioner may be brought into contact with the surface of the polishing pad 4 to perform polishing while conditioning the surface of the polishing pad 4, according to the necessity.

Here, at the time when polishing is performed using the polisheing machine 10 while the polishing agent 5 is used in cycles, a newly prepared unused polishing agent 5 is stored in the polishing agent tank 8 in a certain amount at the start of polishing. In the method of the invention, the polishing agent before use means the polishing agent at this time point, and the polishing agent contains at least one kind of an abrasive at a content of 2 to 40% by mass based on the total amount of the polishing agent. The content is taken as an initial content of the abrasive in the polishing agent. With regard to the polishing agent, it is possible to use the same polishing agents as those described for the above-mentioned additive for a polishing agent of the invention. Preferred embodiments of the polishing agent to be an object can be the same as mentioned above.

In the polishing machine 10, in the case where the polishing agent is used in cycles, the polishing agent 5 in the polishing agent tank 8 is sequentially supplied from the polishing agent tank to the polishing pad, used for polishing, and finally recovered to the polishing agent tank. Here, in such a polishing machine, with regard to the event that the surface to be polished of the object to be polished (single-crystal substrate) is at least once polished using the polishing agent, a cycle in which the polishing agent 5 in the polishing agent tank 8 is supplied to the polishing pad, used for polishing, and finally recovered to the polishing agent tank is referred to as “once polishing”. Moreover, the at least once used polishing agent means a polishing agent on and after the time when the polishing agent is recovered and returned to the polishing agent tank 8 after the polishing agent supplied to the polishing pad at the start of polishing is used for polishing and the polishing agent after use is mixed into the polishing agent in a unused state. Incidentally, the once used polishing agent is in a state of containing a polished matter of the single-crystal substrate that is an object to be polished.

### (Step (2))

The step (2) is a step of adding, to the polishing agent after the above-mentioned step (1), an additive for a polishing agent containing polishing-assistant particles whose average primary particle size is from 0.04 to 0.34 times the average primary particle size of the maximum particle size abrasive having the maximum average primary particle size in the abrasive so that the content of the polishing-assistant particles based on the total amount of the polishing agent in the polishing agent after addition becomes from 0.05 to 20 times the initial content of the abrasive in the polishing agent.

With regard to the additive for a polishing agent to be used, the additive for a polishing agent of the invention is preferably used. The adding amount of the additive for a polishing agent and a specific time for addition are the same as those described for the use of the additive for a polishing agent of the invention.

Here, in the case where polishing by the polishing method of the invention is performed using the polishing machine 10, to the polishing agent tank 8, a predetermined amount of the additive for a polishing agent is supplied for the polishing agent that is at least once used for polishing from the tank 11 of the additive for a polishing agent through the supply tube 12 of the additive for a polishing agent. In the middle of the supply tube 12 of the additive for a polishing agent, the supply means 13 of the additive for a polishing agent for supplying the additive for a polishing agent to the polishing agent tank 8 is disposed. The polishing machine 10 preferably has a control mechanism for monitoring the polishing characteristics of the polishing agent 5 to control the supply of the additive for a polishing agent to the polishing agent tank 8, although the mechanism is not shown in the figure. In the case where it has the control mechanism, the control mechanism is connected to the supply means 13 of the additive for a polishing agent, and the supply of the additive for a polishing agent to the polishing agent tank 8 is controlled by controlling the supply means 13 of the additive for a polishing agent.

In the polishing machine 10, the additive for a polishing agent is added to the polishing agent by performing the supply of the additive for a polishing agent to the polishing agent tank 8. The polishing agent tank 8 usually has a stirring device for stirring (not shown in the figure), whereby a homogeneous mixing of the polishing agent 5 and the additive for a polishing agent is possible. Here, a supplying site of the additive for a polishing agent is not limited and, for example, the addition of the additive for a polishing agent to the polishing agent may be performed in the polishing agent supply tube 6 by adopting such a constitution that the additive for a polishing agent is supplied from the tank 11 of the additive for a polishing agent to the polishing agent supply tube 6 through the supply tube 12 of the additive for a polishing agent. Moreover, the addition of the additive for a polishing agent to the polishing agent may be performed on the polishing pad 4 by adopting such a constitution that the additive for a polishing agent is supplied from the tank 11 of the additive for a polishing agent onto the polishing pad 4 through the supply tube 12 of the additive for a polishing agent.

In the polishing method of the invention, it is possible to suppress the decrease in the polishing characteristics of the polishing agent to be repeatedly used, particularly the removal rate by including the above-mentioned polishing step and addition step. Moreover, in the polishing method of the invention, it is preferred to repeat the above-mentioned polishing step and addition step in this order. With regard to the number of times of repetition, the repetition is conducted until a time point at which the effect of suppressing the decrease in the polishing characteristics, the effect being induced by the addition of the additive for a polishing agent added at the addition step, is finally not exhibited. The relationship between the polishing step and the addition step and an appropriate time of the addition step at the time of the repetition, and the addition method of the additive for a polishing agent are as described in the method of use of the additive for a polishing agent of the invention.

Specifically, the time for performing the addition step is preferably a time at which the polishing performance in the polishing agent after the polishing step is deteriorated as compared to the initial polishing performance or as compared to the polishing performance of the polishing agent immediately after the last addition step in the case where the polishing step and the addition step are repeatedly performed in order.

A specific degree of the decrease in the polishing performance at the time when the addition step is performed is appropriately selected depending on the kinds of the single-crystal substrate as an object to be polished and the surface to be polished, required accuracy, productivity and the like. For example, there may be mentioned a time for addition at which the removal rate is decreased to 50 to 85% of the initial rate or of the polishing performance of the polishing agent immediately after the last addition step.

Here, in the polishing machine 10, the polishing agent 5 is repeatedly used by the cyclic use but, in the polishing method of the invention, the polishing method of the invention can be applied to the case where the polishing agent recovered in a batch use is repeatedly used without limitation to the cyclic use as long as the polishing agent is repeatedly used.

In the above, the mode for carrying out the polishing method of the invention is described with reference to an example thereof but the polishing method of the invention is not limited thereto. The constitution can be appropriately changed unless it is against the gist of the invention or as needed.

According to the polishing method of the invention, in the polishing method using a polishing agent to be repeatedly used, it is possible to suppress the decrease in the polishing characteristics of the polishing agent, particularly the removal rate. Thereby, not only the efficiency of the polishing step is improved, but also the downtime is shortened by a reduction in the consumption of the polishing agent or a decrease in dressing or flashing frequency of the pad, further, this also leads to a reduction in the consumption of the pad. Thus, the polishing step can be efficiently performed and hence, it can be said that the significance for improvement in mass production of various devices is very large.

### EXAMPLES

The invention will be described below with reference to examples, but the invention should not be construed as being limited to the following description. Examples 1 to 6 are preparation examples of additives for a polishing agent. Examples 7 to 16 are working examples with regard to the polishing method of the invention, and Examples 17 to 25 are comparative examples thereof.

The average primary particle sizes of the fine particles used below are all average primary particle sizes each obtained by converting the specific surface area measured by a nitrogen adsorption BET method to the diameter of spherical particles.

### Example 1 to 6

There was prepared Additive 1 (Example 1) for a polishing agent in which colloidal silica (silicon oxide fine particles) having an an average primary particle size of 5 nm as polishing-assistant particles was dispersed at a ratio in terms of % by mass based on the total amount of the additive in water that is a dispersion medium. Similarly, there were prepared Additives 2 to 6 for a polishing agent in which each of polishing-assistant particles whose average primary particle size and kind of the oxide fine particles were shown in Table 1 was dispersed at a content [% by mass] shown in Table 1.

TABLE 1

| | Additive for | Polishing-Assistant Particles | | | |
|---|---|---|---|---|---|
| | Polishing | | Average Primary | Content | Water Content |
| | Agent | Kind | Particle Size [nm] | [% by mass] | [% by mass] |
| Example 1 | 1 | Silicon oxide | 5 | 30 | 70 |
| Example 2 | 2 | Silicon oxide | 10 | 30 | 70 |
| Example 3 | 3 | Tin oxide | 10 | 40 | 60 |
| Example 4 | 4 | Silicon oxide | 27 | 40 | 60 |
| Example 5 | 5 | Silicon oxide | 45 | 40 | 60 |
| Example 6 | 6 | Silicon oxide | 80 | 40 | 60 |

### Examples 7 to 25

Using each of the above-mentioned additives for a polishing agent, polishing was performed by each of polishing methods of Examples 7 to 25. Polishing agents, an object to be polished, a polishing machine, and a polishing pad used for the polishing are as follows.

### (Polishing Agent)

Polishing Agents 1 to 7 each having a composition shown in Table 2 were prepared by the following method.

Colloidal silica having an average primary particle size of 10 nm (an aqueous dispersion of silicon oxide fine particles having a solid concentration of 40% by mass) as first abrasive and colloidal silica having an average primary particle size of 80 nm (an aqueous dispersion of silicon oxide fine particles having a solid concentration of 40% by mass) as second abrasive were mixed at such a ratio that the compounding ratio of the first abrasive to the total amount of the first abrasive and the second abrasive became 30% by mass, followed by thorough stirring.

Ion-exchange water was added to the resulting mixed liquid in such a manner that the total amount of the first abrasive and the second abrasive based on the total mass of the polishing agent to be finally obtained, i.e., the total mass of the total amount of the first abrasive and the second abrasive and the amount of water, became 5% by mass, to prepare Polishing Agent 1. In Polishing Agent 1, the second abrasive is the maximum particle size abrasive. Similarly, Polishing Agents 2 to 7 each having a composition shown in Table 2 were prepared or made ready. Incidentally, Polishing Agent 7 is a polishing agent which is prepared for the use in Comparative Examples, contains the abrasive at a content of 1.5% by mass based on the total amount of the polishing agent, and is not an object to which the additives for a polishing agent and the polishing methods of the invention are applied.

TABLE 2

| | Polishing Agent Composition | | | | | |
|---|---|---|---|---|---|---|
| | Abrasive Composition | | | | | |
| | First Abrasive | | Second Abrasive | | | |
| | (colloidal silica) | | (colloidal silica) | | | |
| | | Average | | Average | Content of | |
| | Compounding | Primary | Compounding | Primary | Abrasive | Water |
| | Amount | Particle Size | Amount | Particle Size | (total) | Content |
| | [% by mass] | [nm] | [% by mass] | (A) [nm] | [% by mass] | [% by mass] |
| Polishing Agent | 30 | 10 | 70 | 80 | 5 | 95 |
| 1 | | | | | | |
| Polishing Agent | 30 | 5 | 70 | 30 | 5 | 95 |
| 2 | | | | | | |
| Polishing Agent | 30 | 17 | 70 | 120 | 5 | 95 |
| 3 | | | | | | |
| Polishing Agent | 30 | 10 | 70 | 80 | 2 | 98 |
| 4 | | | | | | |
| Polishing Agent | 30 | 10 | 70 | 80 | 26 | 74 |
| 5 | | | | | | |
| Polishing Agent | 0 | — | 100 | 80 | 26 | 74 |
| 6 | | | | | | |
| Polishing Agent | 30 | 10 | 70 | 80 | 1.5 | 98.5 |
| 7 | | | | | | |

### (Object to be Polished, Polishing Machine, Polishing Pad)

Object to be polished: a 2-inch wafer of a single-crystal sapphire substrate (manufactured by Shinkosha Co., Ltd., (C) plane, thickness of substrate: 420 μm)

Polishing machine: FAM12B (manufactured by Speedfam Co., Ltd), single wafer polishing

Polishing pad: H7000 (trade name, manufactured by Fujibo)

### <Polishing Test>

### (1) Polishing by Repeated Uses of Polishing Agent

After the polishing pad was dressed with a brush, polishing was performed 16 times with counting the polishing using the polishing agent under the following conditions as one time.

Supply rate of polishing agent: 200 cm³/min

Number of rotations of polishing platen: 100 rpm

Polishing pressure: 200 gf/cm²

Polishing time: 60 minutes

### (2) Addition of Additive for Polishing Agent and Polishing

In each example, as shown in Table 3, to any of Polishing Agents 1 to 7 after use which had been used in 16 times of polishing, any of Additives 1 to 6 prepared in the above-mentioned Examples 1 to 6 was added so that the content (Y) of the polishing-assistant particles based on the total amount of the polishing agent in the polishing agent after addition became an amount shown in Table 3. After the addition of the additive, another once polishing (17 times in total) was performed in all the examples. In Example 17 and Example 25, another once polishing (17 times in total) was performed without adding any additive for a polishing agent.

### (Measurement of Removal Rate)

In each example, the measurement of the removal rate was performed for first polishing, sixteenth polishing, and seventeenth polishing by the following method.

### (Measurement Method of Removal Rate)

The removal rate was evaluated by the amount of change in thickness of the substrate per unit time (μm/hr). Specifically, with respect to each of the single-crystal sapphire substrates used for the above-mentioned evaluation, the mass of the unpolished substrate having a known thickness and the mass of the substrate after polished for each period of time were measured, and the mass change was determined from the difference therebetween. Further, the change in thickness of the substrate per period of time determined from the mass change was calculated using the following formulas.

### (Calculation Formulas of Removal Rate (V))

Δm=m0−m1

V=Δm/m0*T0*60/t

(in the formulas, Δm (g) represents the mass change between before and after polishing, m(0) (g) represents the initial mass of the unpolished substrate, m1 (g) represents the mass of the substrate after polished, V represents the removal rate (μm/hr), T0 represents the substrate thickness (μm) of the unpolished substrate, and t represents the polishing time (min).

The removal rate at the first polishing is represented by V1 as the initial removal rate. Moreover, the removal rate at the sixteenth polishing and the removal rate at the seventeenth polishing are represented by V16 and V17, respectively.

In Table 3, together with the kind of the polishing agent, the kind of the additive for a polishing agent, and the adding amount used in each example, the initial removal rate V1, the ratio of V16 to V1 (V16/V1), and the ratio of V17 to V1 (V17/V1) are shown.

Furthermore, the average primary particle size (A) of the maximum particle size abrasive in the polishing agent, the average primary particle size (B) of the polishing-assistant particles in the additive for a polishing agent, the ratio of (B) to (A) ((B)/(A)), and the initial content (X) of the abrasive in the polishing agent, the content (Y) of the polishing-assistant particles based on the total amount of the polishing agent in the polishing agent after the additive for a polishing agent is added and the ratio of (Y) to (X) ((Y)/(X)) are collectively shown in Table 3.

TABLE 3

| | Polishing | | | | Ratio | Additive for | | Polishing Agent | | | Ratio |
|---|---|---|---|---|---|---|---|---|---|---|---|
| | Agent (initial) | | | | of Re- | Polishing Agent | | (after addition) | | | of Re- |
| | | Average | | | moval | | | Content | Ratio | | moval |
| | | Primary | | | Rate | | Average | of | of | Ratio | Rate |
| | | Particle | | | of | | Primary | Polish- | Particle | of | of First |
| | | Size of | Content | | Six- | | Particle | ing- | Size of | Content | Time |
| | | Maximum | of | Initial | teenth | | Size of | Assis- | Assistant | of | after |
| | Kind | particle | Abrasive | Remo- | Time | Kind of | Polishing- | tant | Particles | Additive | Addition |
| | of | Size | (total) | val | to | Additive | Assistant | Particles | to | to | to |
| | Polish- | Abrasive | (X) | Rate | Initial | for | Particles | (Y) | Abrasive | Abrasive | Initial |
| | ing | (A) | [% by | (V1) | (V16/ | Polishing | (B) | [% by | (large) | (total) | (V17/ |
| | Agent | [nm] | mass] | [μm/hr] | V1) | Agent | [nm] | mass] | (B)/(A) | (Y)/(X) | V1) |
| Example | Polish- | 80 | 5 | 1.5 | 0.53 | Additive | 10 | 0.26 | 0.13 | 0.05 | 1.27 |
| 7 | ing | | | | | 2 | | | | | |
| Example | Agent 1 | 80 | 5 | 1.5 | 0.53 | Additive | 5 | 0.26 | 0.06 | 0.05 | 1.20 |
| 8 | | | | | | 1 | | | | | |
| Example | | 80 | 5 | 1.5 | 0.53 | Additive | 27 | 0.26 | 0.34 | 0.05 | 1.13 |
| 9 | | | | | | 4 | | | | | |
| Example | Polish- | 30 | 5 | 1.35 | 0.59 | Additive | 10 | 0.26 | 0.33 | 0.05 | 0.90 |
| 10 | ing | | | | | 2 | | | | | |
| | Agent 2 | | | | | | | | | | |
| Example | Polish- | 120 | 5 | 1.2 | 0.63 | Additive | 5 | 0.26 | 0.04 | 0.05 | 0.87 |
| 11 | ing | | | | | 1 | | | | | |
| | Agent 3 | | | | | | | | | | |
| Example | Polish- | 80 | 2 | 1.4 | 0.54 | Additive | 10 | 0.11 | 0.13 | 0.05 | 1.20 |
| 12 | ing | | | | | 2 | | | | | |
| Example | Agent 4 | 80 | 2 | 1.4 | 0.54 | Additive | 10 | 18.00 | 0.13 | 9.00 | 1.47 |
| 13 | | | | | | 2 | | | | | |
| Example | Polish- | 80 | 26 | 1.8 | 0.72 | Additive | 10 | 1.30 | 0.13 | 0.05 | 0.87 |
| 14 | ing | | | | | 2 | | | | | |
| | Agent 5 | | | | | | | | | | |
| Example | Polish- | 80 | 26 | 1.5 | 0.67 | Additive | 10 | 1.30 | 0.13 | 0.05 | 0.87 |
| 15 | ing | | | | | 2 | | | | | |
| Example | Agent 6 | 80 | 26 | 1.5 | 0.67 | Additive | 10 | 1.30 | 0.13 | 0.05 | 0.87 |
| 16 | | | | | | 3 | | | | | |
| Example | Polish- | 80 | 5 | 1.5 | 0.53 | None | — | — | — | — | 0.67 |
| 17 | ing | | | | | | | | | | |
| Example | Agent 1 | 80 | 5 | 1.5 | 0.53 | Additive | 45 | 0.26 | 0.56 | 0.05 | 0.63 |
| 18 | | | | | | 5 | | | | | |
| Example | | 80 | 5 | 1.5 | 0.53 | Additive | 80 | 0.26 | 1.00 | 0.05 | 0.67 |
| 19 | | | | | | 6 | | | | | |
| Example | Polish- | 80 | 2 | 1.4 | 0.54 | Additive | 10 | 0.04 | 0.13 | 0.02 | 0.67 |
| 20 | ing | | | | | 2 | | | | | |
| | Agent 4 | | | | | | | | | | |
| Example | Polish- | 80 | 1.5 | 1 | 0.70 | Additive | 10 | 0.03 | 0.13 | 0.02 | 0.47 |
| 21 | ing | | | | | 2 | | | | | |
| Example | Agent 7 | 80 | 1.5 | 1 | 0.70 | Additive | 10 | 0.08 | 0.13 | 0.05 | 0.50 |
| 22 | | | | | | 2 | | | | | |
| Example | | 80 | 1.5 | 1 | 0.70 | Additive | 10 | 13.50 | 0.13 | 9.00 | 0.57 |
| 23 | | | | | | 2 | | | | | |
| Example | Polish- | 80 | 26 | 1.8 | 0.72 | Additive | 10 | 0.41 | 0.13 | 0.02 | 0.67 |
| 24 | ing | | | | | 2 | | | | | |
| | Agent 5 | | | | | | | | | | |
| Example | Polish- | 80 | 26 | 1.5 | 0.67 | None | — | — | — | — | 0.67 |
| 25 | ing | | | | | | | | | | |
| | Agent 6 | | | | | | | | | | |

As will be seen from Table 3, the removal rate is high in the case where the content of the abrasive in the polishing agent is from 2 to 40% by mass, the ratio of the average primary particle size (B) of the polishing-assistant particles in the additive for the polishing agent to the average primary particle size (A) of the maximum particle size abrasive in the polishing agent, (B)/(A), is from 0.04 to 0.34 times and the ratio of the content (Y) of the polishing-assistant particles based on the total amount of the polishing agent in the polishing agent after the additive for a polishing agent is added to the initial content (X) of the abrasive in the polishing agent, (Y)/(X), is from 0.05 to 20 times. Incidentally, in the above-mentioned polishing test, the surfaces to be polished of all single-crystal sapphire substrates were polished to high quality.

### INDUSTRIAL APPLICABILITY

According to the invention, it becomes possible to perform long-term polishing of surfaces to be polished of objects to be polished, particularly single-crystal substrates having high hardness, such as sapphire (α-Al₂O₃) substrates, silicon carbide (SiC) substrates and gallium nitride (GaN) substrates with maintaining high quality. Thereby, the invention can contribute to improvement in productivity of these substrates.

The present application is based on Japanese Patent Application No. 2011-285032 filed on Dec. 27, 2011, and the contents are incorporated herein by reference.

### DESCRIPTION OF REFERENCE NUMERALS AND SIGNS

1 . . . Object to be polished, 2 . . . Polishing head, 3 . . . Polishing platen, 4 . . . Polishing pad, 5 . . . Polishing agent, 6 . . . Polishing agent supply tube, 7 . . . Polishing agent supply means, 8 . . . Polishing agent tank, 10 . . . Polishing machine, 11 . . . Tank of additive for polishing agent, 12 . . . Supply tube of additive for polishing agent, 13 . . . Supply means of additive for polishing agent

1. An additive for a polishing agent including polishing-assistant particles, which is added, to a polishing agent which is repeatedly used for polishing a surface to be polished of a single-crystal substrate and contains at least one kind of an abrasive whose initial content before use is from 2 to 40% by mass based on a total amount of the polishing agent, in a state that the polishing agent contains a polished matter of the single-crystal substrate after the polishing agent is at least once used for polishing,
wherein an average primary particle size of the polishing-assistant particles is from 0.04 to 0.34 times an average primary particle size of a maximum particle size abrasive having a maximum average primary particle size in the abrasive, and a content of the polishing-assistant particles in the additive is such a content that the content of the polishing-assistant particles based on the total amount of the polishing agent in the polishing agent after the additive is added to the polishing agent in a predetermined amount becomes from 0.05 to 20 times the initial content of the abrasive in the polishing agent.

2. The additive for a polishing agent according to claim 1, wherein the polishing-assistant particles are oxide fine particles.

3. The additive for a polishing agent according to claim 1, wherein the polishing-assistant particles are selected from silicon oxide fine particles and tin oxide fine particles.

4. The additive for a polishing agent according to claim 1, wherein the polishing agent contains an abrasive obtained by combining first silicon oxide fine particles having an average primary particle size of 5 to 30 nm and second silicon oxide fine particles having an average primary particle size of 20 to 180 nm so that the average primary particle size of the first silicon oxide fine particles becomes smaller than the average primary particle size of the second silicon oxide fine particles, and water, and a ratio of the first silicon oxide fine particles to a total amount of the first silicon oxide fine particles and the second silicon oxide fine particles is from 0.7 to 70% by mass.

5. The additive for a polishing agent according to claim 1, wherein the initial content of the abrasive in the polishing agent is from 2 to 10% by mass based on the total amount of the polishing agent, the average primary particle size of the maximum particle size abrasive of the abrasive in the polishing agent is from 50 to 100 nm, and the average primary particle size of the polishing-assistant particles is from 0.05 to 0.32 times the average primary particle size of the maximum particle size abrasive.

6. The additive for a polishing agent according to claim 5, wherein the average primary particle size of the polishing-assistant particles is from 0.06 to 0.29 times the average primary particle size of the maximum particle size abrasive.

7. A polishing method comprising supplying a polishing agent to a polishing pad and bringing the polishing pad into contact with a surface to be polished of a single-crystal substrate that is an object to be polished to perform polishing by relative movement between both, wherein a polishing agent which contains at least one kind of an abrasive whose initial content before use is from 2 to 40% by mass based on a total amount of the polishing agent and which is repeatedly used, is used as the polishing agent, and the method includes the following steps (1) and (2):
(1) a step of polishing the surface to be polished at least once, using the polishing agent; and
(2) a step of adding, to the polishing agent after the step (1), an additive for a polishing agent, containing polishing-assistant particles whose average primary particle size is from 0.04 to 0.34 times an average primary particle size of a maximum particle size abrasive having a maximum average primary particle size in the abrasive, so that a content of the polishing-assistant particles based on the total amount of the polishing agent in the polishing agent after addition becomes from 0.05 to 20 times the initial content of the abrasive in the polishing agent.

8. The polishing method according to claim 7, wherein the polishing agent is used in cycles by repeating an operation of recovering the polishing agent supplied to the polishing pad and used for polishing and again supplying the recovered polishing agent to the polishing pad, and the steps (1) and (2) are repeatedly performed in order.

9. The polishing method according to claim 7, wherein a time at which the step (2) is performed is a time when polishing performance of the polishing agent after the step (1) is deteriorated as compared to initial polishing performance or as compared to polishing performance of the polishing agent immediately after the last step (2) in a case where the step (1) and the step (2) are repeatedly performed in order.
